(19) United States
(12) Patent Application Publication
(10) Pub. No.: US 2015/0284512 A1
(43) Pub. Date: Oct. 8, 2015

(54) POLYAMIC ACID SOLUTION, IMIDIZATION FILM, AND DISPLAY DEVICE

(71) Applicant: KOLON INDUSTRIES, INC., Gyeonggi-do (KR)

(72) Inventors: Woong Ki Min, Yongin-si (KR); Hak Gee Jung, Yongin-si (KR); Hyo Jun Park, Yongin-si (KR); Ki Il Hong, Yongin-si (KR)

(73) Assignee: KOLON INDUSTRIES, INC., Gwacheon-si, Gyeonggi-do (KR)

(21) Appl. No.: 14/435,656

(22) PCT Filed: Dec. 17, 2013
(86) PCT No.: PCT/KR2013/011706

§ 371 Date: Apr. 14, 2015

(30) Foreign Application Priority Data
Dec. 26, 2012 (KR) 10-2012-0152735

(51) Int. Cl. C08G 73/10; C09D 179/08

(52) U.S. Cl. CPC C08G 73/1007; C08G 73/1067; C08G 73/1085; C09D 179/08; C08G 73/1042

(57) ABSTRACT

The present invention relates to a polyamic acid solution, an imidization film, and a display device, and discloses a polyamic acid solution which is a reaction product of dianhydrides and aromatic diamines and has a thermal expansion coefficient of 10 ppm/° C. or less in a temperature range of 50 to 540° C., after forming an imidization film, an imidization film thereof, and a display device including the same. The present invention may provide a display having excellent thermal stability, proper flexibility, and mechanical strength by applying the polyamic acid solution.

### TECHNICAL FIELD

The present invention relates to a polyamic acid solution, an imidization film, and a display device, and more particularly, to a high heat resistance polyamic acid solution which is usable as a base layer or a protective layer of the display device, an imidization film thereof, and a display device including the same.

### BACKGROUND ART

A ubiquitous age to transmit and receive information anywhere and anytime regardless of a place is entering, and digital convergence in which computers, communications, and information appliances are fused or combined is rapidly progressing. As a result, a display which serves as an interface between an electronic information device and a human has been more important. In addition, a demand for high-resolution, high-brightness, and high-definition image information is further increased, and a large-sized liquid crystal display, a plasma display, an organic light emitting diode (OLED) display have been completed.

Recently, a display which is thin, light, bent or curved has received attention, and in order to implement the display having the characteristics, a substrate using a new material having flexibility instead of an existing glass substrate has been required.

A form of a currently developed flexible display is an OLED or TFT LCD form, and a mode of driving the display by placing a structure such as a TFT on a flexible polymer material substrate, and a mode of configuring a unit device for driving the display by structuring a gate, an insulating layer, a source, and a drain on the polymer material substrate and finally placing electrodes. However, since the above device manufacturing process is often performed at a high temperature, a dimension of the polymer material substrate during manufacturing is easily deformed, and thermal de-naturalization is caused, and as a result, a circuit pattern is misaligned or a surface property of the polymer substrate is changed, and there is a problem to be used as display substrate.

Further, since a plastic film itself of a plastic material does not have supporting force, an adhering process using an adhesive on the metal foil or the glass plate is additionally required, and when the adhering is not smoothly performed, the plastic film may have a smoothness problem.

### DISCLOSURE OF INVENTION

### Technical Problem

Therefore, an aspect of the present invention provides a polyamic acid solution which is useful to form a base layer or a protective layer of a display device by having a low thermal expansion coefficient due to excellent heat resistance when a film is formed, as a polymer material with which the film is formed even at a high temperature.

An aspect of the present invention also provides an imidization film which is useful as a base layer or a protective layer of a display device due to excellent heat resistance and a low thermal expansion coefficient.

An aspect of the present invention also provides a display device including an imidization film having high heat resistance and a low thermal expansion coefficient as a base layer or a protective layer.

### Solution to Problem

According to a preferred embodiment of the present invention, there is provided a polyamic acid solution which is a reaction product of dianhydrides and aromatic diamines and has a thermal expansion coefficient of 10 ppm/° C. or less in a temperature range of 50 to 540° C., after forming an imidization film.

According to a preferred embodiment, the polyamic acid solution may not be carbonized during heat treatment in the temperature range of 50 to 570° C. to form the substantially stable imidization film.

In above and below disclosure, the “substantially stable imidization film” may be an imidization film which is a film formation state enough to be recognized as a film by those skilled in the art when the formed imidization film is verified with the naked eyes, and may not include the film formation state enough to be recognized to be brittle.

In the polyamic acid solution according to the preferred embodiment of the present invention, the aromatic diamines may include 2-(4-Aminophenyl)-6-aminobenzoxazole.

In the polyamic acid solution according to the preferred embodiment of the present invention, the aromatic dianhydrides may be monomers selected from rigid dianhydrides without —O—, —CO—, —S—, —CONH— —SO₂—, —CO—O—, —CH₂—, or —C(CH₃)₂- chain between aromatic rings.

In the polyamic acid solution according to the preferred embodiment of the present invention, the aromatic diamines may include monomers selected from rigid diamines without —O—, —CO—, —S—, —CONH— —SO₂—, —CO—O—, —CH₂—, or —C(CH₃)₂- chain between aromatic rings, in addition to 2-(4-Aminophenyl)-6-aminobenzoxazole.

According to another preferred embodiment of the present invention, there is provided an imidization film which is an imidized compound of a reaction product of dianhydrides and aromatic diamines and has a thermal expansion coefficient of 10 ppm/° C. or less in a temperature range of 50 to 540° C., after forming an imidization film.

In the imidization film according to the preferred embodiment of the present invention, the aromatic diamines may include 2-(4-Aminophenyl)-6-aminobenzoxazole.

In the imidization film according to the preferred embodiment of the present invention, the aromatic dianhydrides may be monomers selected from rigid dianhydrides without —O—, —CO—, —S—, —CONH— —SO₂—, —CO—O—, —CH₂—, or —C(CH₃)₂- chain between aromatic rings.

In the imidization film according to the preferred embodiment of the present invention, the aromatic diamines may include monomers selected from rigid diamines without —O—, —CO—, —S—, —CONH— —SO₂—, —CO—O—, —CH₂—, or —C(CH₃)₂- chain between aromatic rings, in addition to 2-(4-Aminophenyl)-6-aminobenzoxazole.

An exemplary embodiment of the present invention provides a display device including the imidizaiton film according to the above-described embodiments.

Here, the imidizaiton film may be a protective layer or a base layer of the display device.

In the above and below disclosure, the display device may be a flexible display device.

### Advantageous Effects of Invention

According to the present invention, the polyamic acid solution of the present invention may ensure excellent dimensional stability in a high temperature process like a manufacturing of the display device, and particularly, be applied even to the base layer or the protective layer for the display device in which flexibility is required. Further, since an adhesive needs not to be used for a support (a metal foil, a glass plate, and the like) used for fixing, an additional process for adhering is not required and the process may be simplified, and in the case of manufacturing the display device, a manufacturing process of the display device may be easily designed regardless of a temperature.

### BEST MODE FOR CARRYING OUT THE INVENTION

Unless otherwise defined, all technical and scientific terms used herein have the same meaning as those which are commonly understood by those skilled in the art to which this invention belongs. Generally, the nomenclature used herein is well known in the art and is the nomenclature normally used.

As used herein, when any part “includes” or “contains” any element, this indicates that other elements are not excluded but may be further included unless otherwise specifically mentioned.

Hereinafter, the present invention will be described in detail.

The present invention, as a preferable embodiment, provides a polyamic acid solution which is a reaction product of aromatic dianhydride and aromatic diamine, and having a thermal expansion coefficient of 10 ppm/° C. or less in the temperature range of 50 to 540° C., after forming an imidization film.

Further, the polyamic acid solution is not carbonized in a process of forming the imidization film by heat treatment at 50° C. to 570° C. to form a substantially stable imidization film.

The thermal expansion coefficient in the temperature range is to consider dimensional stability which simulates a thermal environment change going through a manufacturing process of the display device when the imidization film imidized after coating the polyamic acid solution is applied as a base layer or a protective layer.

In the display device, the base layer is repetitively exposed under a high-temperature environment during the manufacturing process of the display device, and in this case, as the thermal expansion coefficient is smaller, it is advantageous to manufacture the display device, and further, it is advantageous to easily design the manufacturing process as values of the thermal expansion coefficient are uniform within a process temperature range. That is, as the values of the thermal expansion coefficient are not changed at a low temperature or high temperature, it is advantageous to manufacture the display device. Eventually, in the display device for a display, the base layer needs to have a low thermal expansion coefficient and a thermal expansion linear rate.

That is, in a process of manufacturing an electrode, a driving device, when the process temperature exceeds 500° C. and the thermal expansion coefficient is large, considering that the display device is bent and the driving device and the like are misaligned, the thermal expansion coefficient measured at 50 to 540° C. when the polyamic acid solution forms the imidization film may be 10 ppm/° C. or less.

One of various embodiments for providing such a polyamic acid solution may include 2-(4-Aminophenyl)-6-aminobenzoxazole (Ar2) as aromatic diamines when the polyamic acid solution is prepared.

The Ar2 may be one of aromatic diamines having a rigid structure capable of granting a high-temperature resistance characteristic.

In addition, when the polyamic acid solution is prepared, a dianhydride monomer without a flexible chain on a molecular structure may be used as the dianhydride.

Further, in addition to the Ar2, a diamine monomer without the flexible chain on the molecular structure may be used as the aromatic diamines.

Here, the monomer (hereinafter, referred to as a rigid monomer) without a flexible chain on a molecular structure may be defined as a monomer without —O—, —CO—, —S—, —CONH— —SO₂—, —CO—O—, —CH₂—, or —C(CH₃)₂- chain, that is, the flexible chain between aromatic rings.

For example, the dianhydride may include 3,3′,4,4′-Biphenyltetracarboxylic Dianhydride (BPDA), 1,2,4,5-benzenetetracarboxylic dianhydride (PMDA), or the like, and the diamine may include para-Phenylene Diamine (pPDA), meta-Phenylene Diamine (mPDA), 4-aminophenylbenzamide (APBA), or the like, but they are not limited thereto.

A polyamic acid which is a polymer using the rigid monomers may satisfy high-temperature resistance.

General diamines and dianhydrides may be used as an equimolar amount of a molar ratio of 1:0.99 to 0.99:1, and if a molar ratio range of the monomers for satisfying the above-described object, a kind of dianhydride and a kind of diamine may be used, two or more kinds of dianhydrides and one or more kinds of diamines may be used, or two or more kinds of diamines and one or more dianhydrides may be used.

Meanwhile, as the diamines, the Ar2 may be used independently or in a combination with another rigid monomer, and when the rigid monomer is used as the dianhydrides, the high-temperature resistance may be further satisfied according to an increase of a use amount of Ar2 among the diamines. However, according to a combination of dianhydrides, the heat expansion coefficient may be decreased, and the polyamic acid solution is carbonized during heat treatment at 50° C. to 570° C. and thus the film may not be formed.

However, despite a proper combination ratio of the dianhydrides, as the diamines, in the case of including the Ar2 or combining the Ar2 under a predetermined content, it is difficult to express the high-temperature resistance.

When the polyamic acid soulution as a polyimide precursor is polymerized, a dianhydride component and a diamine component are dissolved in an organic solvent at a substantially equimolar amount and react with each other to prepare the polyamic acid soulution.

The polymerization reaction conditions are not particularly limited. However, it is preferred that the reaction temperature be −20 to 80° C., and that the reaction time be 2 to 48 hours. Further, it is more preferred that the polymerization reaction be conducted under an inert gas atmosphere of argon, nitrogen or the like.

The organic solvent used for the polymerization of the polyamic acid solution is not particularly limited as long as it can dissolve polyamic acid. A known reaction solvent uses at least one polar solvent selected from m-cresol, N-methyl-2-pyrrolidone (NMP), dimethylformamide (DMF), dimethylacetamide (DMAc), dimethylsulfoxide (DMSO), acetone, and diethyl acetate. In addition, as the reaction solvent, a low-boiling solvent such as tetrahydrofuran (THF) and chloroform, or a poorly absorbable solvent such as γ-butyrolactone may be used.

The amount of the organic solvent is not particularly limited. However, in order to obtain a polyamic acid solution having proper molecular weight and viscosity, the amount of the organic solvent is preferably 50 to 95 wt %, and more preferably 70 to 90 wt %, based on the total amount of the polyamic acid solution.

Meanwhile, the polyamic acid solution prepared in this way is imidized to prepare the imidization film. Here, it is preferred that the glass transition temperature of the prepared imidization film is 500° C. or more in terms of thermal stability.

That is, since the polyimide-based polymer shows Tg of 300° C. or more and a low thermal expansion coefficient as a well-known high-temperature resistance material, a TFT and the like may be prepared at a temperature of 300° C. or more, and thus it is advantageous to form a pattern. In addition, since the polyimide-based polymer may be fixed onto a support without using an adhesive, the polyimide-based polymer may be a material which is very advantageous to easily maintain smoothness and implement a flexible display.

The method of preparing the imidization film from the polyamic acid solution may use a method of simulating a manufacturing process of the flexible display, and may include an imidizing method after uniformly coating the polyamic acid solution on the support. That is, in the manufacturing process of the display device, generally, electrodes, a display unit, and the like are sequentially laminated on the base layer, and one method of applying the polyamic acid solution as the base layer may include a method of coating and imidizing the polyamic acid solution on a separate support to prepare the imidization film, performing a process of laminating the display device on the imidization film by a general method, and finally, releasing the support. In this case, it may be advantageous to improve flatness of the base layer as compared with a case where a plastic material of a film form is applied to the substrate.

Further, a polyimide coating layer imidized by coating the polyamic acid solution on a component laminated on the display device may be applied to a protective layer.

In this case, in terms of coating workability and a coating uniformity, it may be preferred that the viscosity of the polyamic acid solution is 50 to 1,000 poise.

As an imidization method which may be applied to form the imidization film, a thermal imidization method, a chemical imidization method, or a combination of the thermal imidization method and the chemical imidization method may be applied. The chemical imidization method is an imidization method by adding a dehydrator which is representative as an acid anhydride such as acetic anhydride and an imidization catalyst which is representative as tertiary amines and the like such as isoquinoline, β-picoline, and pyridine to the polyamic acid solution. In the case of the thermal imidization method or the combination of the thermal imidization method and the chemical imidization method, the heating condition of the polyamic acid solution may be changed according to a kind of polyamic acid solution, a required thickness of the imidization film, and the like.

In the case of the combination of the thermal imidization method and the chemical imidization method, a more detailed example of the method of forming the imidization film will be described. A dehydrator and an imidization catalyst are added to the polyamic acid solution. Then, the polyamic acid solution is cast on a separate support and heated at 80 to 200° C., preferably 100 to 180° C. to activate the dehydrator and the imidization catalyst. Thereafter, the polyamic acid solution is partially cured and dried and then heated at 200 t0 570° C. for 5 to 400 seconds to obtain the imidization film.

A display device component and the like may be laminated on the imidization film by the aforementioned method, and a solution prepared by adding the dehydrator and the imidization catalyst to the polyamic acid solution is coated on the display device component to form the imidization film and then the imidization film may be applied as the protective layer.

The imidization film obtained in this way has a thermal expansion coefficient of 10 ppm/° C. or less in a temperature range of 50 to 540° C.

As described above, by applying the polyamic acid solution to the display device, it is possible to provide a display device having excellent thermal stability, proper flexibility, and mechanical strength.

Hereinafter, the present invention will be described in more detail with reference to the following Examples. However, the scope of the present invention is not limited thereto.

### Example 1

900 g of N,N-dimethylacetamide (DMAc) was filled in a 1L reactor provided with a stirrer, a nitrogen injector, a dripping funnel, a temperature controller, and a cooler as a reactor while passing nitrogen, and then the temperature of the reactor was adjusted to 25° C., and 146.41 g (100 mol %) of diamine Ar2 was dissolved and the solution was maintained to 25° C. 141.41 g (100 mol %) of dianhydride PMDA was added therein, and stirred for 24 hours to obtain a polyamic acid solution having viscosity of 280 poise. In this case, the viscosity of the polyamic acid solution was a value measured by using a Brookfield viscometer.

In order to simulate and evaluate that the polyamic acid solution was used as the base layer or the protective layer for a flexible display, the obtained polyamic acid solution was defoamed in a vacuum and then cooled at room temperature, cast on a stainless plate to a thickness of 60 to 100 μm, dried at 150° C. for 10 minutes or less using hot air, risen up to 450° C., heated up to 570° C. for 1 hour and then slowly cooled, and then separated from the support to obtain a polyamide layer having a thickness of 10 to 15 μm.

### Example 2

900 g of N,N-dimethylacetamide (DMAc) was filled in a 1L reactor provided with a stirrer, a nitrogen injector, a dripping funnel, a temperature controller, and a cooler as a reactor while passing nitrogen, and then the temperature of the reactor was adjusted to 25° C. and 146.41 g (100 mol %) of diamine Ar2 was dissolved and the solution was maintained to 25° C. 127.60 g (90 mol %) of dianhydride PMDA was added therein and completely dissolved, and then 19.12 g (10 mol %) of dianhydride BPDA was added and stirred for 24 hours to obtain a polyamic acid solution having viscosity of 257 poise. In this case, the viscosity of the polyamic acid solution was a value measured by using a Brookfield viscometer.

In order to simulate and evaluate that the polyamic acid solution was used as the base layer or the protective layer for a flexible display, the obtained polyamic acid solution was defoamed in a vacuum and then cooled at room temperature, cast on a stainless plate to a thickness of 60 to 100 μm, dried at 150° C. for 10 minutes or less using hot air, risen up to 450° C., heated up to 570° C. for 1 hour and then slowly cooled, and then separated from the support to obtain a polyamide layer having a thickness of 10 to 15 μm.

### Example 3

900 g of N,N-dimethylacetamide (DMAc) was filled in a 1L reactor provided with a stirrer, a nitrogen injector, a dripping funnel, a temperature controller, and a cooler as a reactor while passing nitrogen, and then the temperature of the reactor was adjusted to 25° C. and 146.41 g (100 mol %) of diamine Ar2 was dissolved and the solution was maintained to 25° C. 99.24 g (70 mol %) of dianhydride PMDA was added therein and completely dissolved, and then 57.37 g (30 mol %) of dianhydride BPDA was added and stirred for 24 hours to obtain a polyamic acid solution having viscosity of 324 poise. In this case, the viscosity of the polyamic acid solution was a value measured by using a Brookfield viscometer.

In order to simulate and evaluate that the polyamic acid solution was used as the base layer or the protective layer for a flexible display, the obtained polyamic acid solution was defoamed in a vacuum and then cooled at room temperature, cast on a stainless plate to a thickness of 60 to 100 μm, dried at 150° C. for 10 minutes or less using hot air, risen up to 450° C., heated up to 570° C. for 1 hour and then slowly cooled, and then separated from the support to obtain a polyamide layer having a thickness of 10 to 15 μm.

### Comparative Example 1

900 g of N,N-dimethylacetamide (DMAc) was filled in a 1L reactor provided with a stirrer, a nitrogen injector, a dripping funnel, a temperature controller, and a cooler as a reactor while passing nitrogen, and then the temperature of the reactor was adjusted to 25° C. and 146.41 g (100 mol %) of diamine Ar2 was dissolved and the solution was maintained to 25° C. 70.89 g (50 mol %) of dianhydride PMDA was added therein and completely dissolved, and then 95.62 g (30 mol %) of dianhydride BPDA was added and stirred for 24 hours to obtain a polyamic acid solution having viscosity of 309 poise. In this case, the viscosity of the polyamic acid solution was a value measured by using a Brookfield viscometer.

In order to simulate and evaluate that the polyamic acid solution was used as the base layer or the protective layer for a flexible display, the obtained polyamic acid solution was defoamed in a vacuum and then cooled to a room temperature, cast on a stainless plate to a thickness of 60 to 100 μm, dried at 150° C. for 10 minutes using hot air, risen up to 450° C., heated up to 570° C. for 1 hour and then slowly cooled, and then separated from the support. However, the polyamic acid solution was carbonized not to obtain a film.

### Comparative Example 2

900 g of N,N-dimethylacetamide (DMAc) was filled in a 1L reactor provided with a stirrer, a nitrogen injector, a dripping funnel, a temperature controller, and a cooler as a reactor while passing nitrogen, and then the temperature of the reactor was adjusted to 25° C. and 70.29 g (100 mol %) of diamine pPDA was dissolved, and the solution was maintained to 25° C. 141.78 g (100 mol %) of dianhydride PMDA is added therein, and stirred for 24 hours to obtain a polyamic acid solution having viscosity of 434 poise. In this case, the viscosity of the polyamic acid solution was a value measured by using a Brookfield viscometer.

In order to simulate and evaluate that the polyamic acid solution was used as the base layer or the protective layer for a flexible display, the obtained polyamic acid solution was defoamed in a vacuum and then cooled to a room temperature, cast on a stainless plate to a thickness of 60 to 100 μm, dried at 150° C. for 10 minutes using hot air, risen up to 450° C., heated up to 570° C. for 1 hour and then slowly cooled, and then separated from the support. However, the polyamic acid solution was carbonized not to obtain a film.

### Comparative Examples 3 to 6

In Comparative Example 2, except that components and added amounts of the diamine and the dianhydride are changed like components and added molar ratios of the following Table 1, the polyamic acid solution was carbonized at 570° C. by the same method not to obtain the film, and the result was as the following Table 1.

### Comparative Examples 7 to 8

In Comparative Example 3, except that components and added amounts of the diamine and the dianhydride are changed like components and added molar ratios of the following Table 1, the polyamic acid solution and the polyimide coating layer were obtained by the same method. With respect to the obtained imidization film, a co-efficient of thermal expansion and a pyrolysis temperature were measured as follows, and the result was as the following Table 1.

(1) Coefficient of Thermal Expansion

Before measuring a coefficient of thermal expansion, a corresponding sample was annealed at 150° C. for 20 minutes to minimize moisture in the film. A measuring method of the coefficient of thermal expansion was performed by cutting a part of a polyimide coating layer sample with a width of 4 mm×a length of 20 mm and measuring the coefficient of thermal expansion by using a thermal mechanical apparatus of Perkin Elmer Corporation. The sample was hung to a quartz hook and force of 50 mN was applied, and then the sample was heated at 35° C. to 540° C. at a heating rate of 10° C./min at nitrogen atmosphere to measure the coefficient of thermal expansion. The coefficient of thermal expansion was calculated up to a first decimal place within a temperature range of 50° C. to 540° C., and a unit was expressed as [ppm/° C].

(2) Film Formation Property

A film formation form of the imidization film obtained by heating the prepared polyamic acid solution at 50 to 570° C. was verified with the naked eye, and a case where the film was formed and the stable imidization film was formed was marked as ‘O’, a case where the formed imidization film was brittle was marked ‘Δ’, and a case where the polyamic acid solution was carbonized and the film was not formed was marked as ‘X’.

(3) Pyrolysis Temperature

A pyrolysis temperature was measured by using a TGA measuring apparatus of Perkin Elmer Corporation. The imidization film was cut with a size of 3 mm×3mm and placed on a preprocessed and measured fan, and then insulated at 110° C. for 30 minutes and cooled at a room temperature, and then heated again up to 700° C. at a velocity of 10° C./min to measure a weight loss. The pyrolysis temperature was calculated by setting a temperature at which a weight loss ratio is 1% to a weight of an initially loaded imidization film.

TABLE 1

| | | | | | Thermal | | Film |
|---|---|---|---|---|---|---|---|
| | Composition (molar ratio %) | | | | expansion | Pyrolysis | formation |
| | Dianhydride | | Diamine | | coefficient | temperature | property |
| Classfication | PMDA | BPDA | Ar2 | pPDA | [ppm/° C.] | [° C.] | (O/Δ/X) |
| Example 1 | 100 | — | 100 | — | −0.21 | 614 | Δ |
| Example 2 | 90 | 10 | 100 | — | 0.84 | 609 | O |
| Example 3 | 70 | 30 | 100 | — | 4.88 | 604 | O |
| Comparative | 50 | 50 | 100 | — | X | X | X |
| Example 1 | | | | | | | |
| Comparative | 100 | — | — | 100 | X | X | X |
| Example 2 | | | | | | | |
| Comparative | 90 | 10 | — | 100 | X | X | X |
| Example 3 | | | | | | | |
| Comparative | 70 | 30 | — | 100 | X | X | X |
| Example 4 | | | | | | | |
| Comparative | 50 | 50 | — | 100 | X | X | X |
| Example 5 | | | | | | | |
| Comparative | 70 | 30 | 10 | 90 | X | X | X |
| Example 6 | | | | | | | |
| Comparative | 70 | 30 | 30 | 70 | 21.84 | 581 | Δ |
| Example 7 | | | | | | | |
| Comparative | 70 | 30 | 50 | 50 | 17.65 | 589 | Δ |
| Example 8 | | | | | | | |

As the property evaluation result, there was no problem to imidize and coat the polyamic acid solution according to the embodiment of the present invention. The polyimide coating layer obtained from the polyamic acid solution according to Examples 1 to 3 may form the film even though the measured result of the coefficient of thermal expansion in the temperature range of 50 to 540° C. was 10 ppm/° C. or less, and the polyimide coating layer was heated up to 570° C. during the film forming process. As a result, in a high temperature process like the manufacturing of the display device, it will be expected to ensure excellent dimensional stability.

On the contrary, the polyimide coating layer obtained from the polyamic acid solution according to Comparative Examples 1 to 6 did not stand the film forming process up to 570° C. to be carbonized, and the reason was that the polyimide coating layer had lower heat resistance than the polyimide coating layer according to the Examples. However, in the Comparative Examples 7 to 8, as the amount of Ar2 increased, the polyimide coating layer was not carbonized to form the film even in the film forming process up to 570° C., but was brittle. From the result, it was verified that the pyrolysis temperature and the coefficient of thermal expansion were slightly decreased to be less optimized for forming the base layer or the protective layer of the display device.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A polyamic acid solution which is a reaction product of dianhydrides and aromatic diamines and has a thermal expansion coefficient of 10 ppm/° C. or less in a temperature range of 50 to 540° C., after forming an imidization film.

2. The polyamic acid solution of claim 1, wherein the polyamic acid solution is not carbonized during heat treatment in the temperature range of 50 to 570° C. to form the substantially stable imidization film.

3. The polyamic acid solution of claim 1, wherein the aromatic diamines include 2-(4-aminophenyl)-6-aminobenzoxazole.

4. The polyamic acid solution of claim 1, wherein the aromatic dianhydrides are monomers selected from rigid dianhydrides without —O—, —CO—, —S—, —CONH— —SO₂—, —CO—O—, —CH₂—, or —C(CH₃)₂- chain between aromatic rings.

5. The polyamic acid solution of claim 1, wherein the aromatic diamines include monomers selected from rigid diamines without —O—, —CO—, —S—, —CONH— —SO₂—, —CO—O—, —CH₂—, or —C(CH₃)₂- chain between aromatic rings, in addition to 2-(4-aminophenyl)-6-aminobenzoxazole.

6. An imidization film which is a imidized compound of a reaction product of dianhydrides and aromatic diamines and has a thermal expansion coefficient of 10 ppm/° C. or less in a temperature range of 50 to 540° C., after forming an imidization film.

7. The imidization film of claim 6, wherein the aromatic diamines include 2-(4-aminophenyl)-6-aminobenzoxazole.

8. The imidization film of claim 6, wherein the aromatic dianhydrides are monomers selected from rigid dianhydrides without —O—, —CO—, —S—, —CONH— —SO₂—, —CO—O—, —CH₂—, or —C(CH₃)₂- chain between aromatic rings.

9. The imidization film of claim 6, wherein the aromatic diamines include monomers selected from rigid diamines without —O—, —CO—, —S—, — —SO₂—, —CO—O—, —CH₂—, or —C(CH₃)₂- chain between aromatic rings, in addition to 2-(4-aminophenyl)-6-aminobenzoxazole.

10. A display device including an imidization film of claim 6.

11. The display device of claim 10, wherein the imidization film includes a protective layer.

12. The display device of claim 10, wherein the imidization film includes a base layer.

13. The display device of claim 10, the display device is a flexible display device.

14. A display device including an imidization film of claim 7.

15. A display device including an imidization film of claim 8.

16. A display device including an imidization film of claim 9.

17. The display device of claim 11, the display device is a flexible display device.

18. The display device of claim 12, the display device is a flexible display device.
